(19) United States
(12) Patent Application Publication
(10) Pub. No.: US 2022/0074054 A1
(43) Pub. Date: Mar. 10, 2022

(54) FOUR-FUNCTION STEEL SURFACE TREATMENT LIQUID AND PREPARATION METHOD THEREOF

(71) Applicant: CHUEN KWOON WAN, Vancouver (CA)

(72) Inventors: Chuen Kwoon Wan, Vancouver (CA); Limei Chen, Vancouver (CA)

(21) Appl. No.: 17/016,344

(22) Filed: Sep. 9, 2020

(51) Int. Cl. C23C 22/62; C23C 22/77; C09D 5/08; C08K 5/521; C08K 5/524; C08K 5/053; C08K 5/405; C08K 3/32; C08K 3/22; C08K 3/30; C08L 65/02; C08L 71/02; C08F 120/06

(52) U.S. Cl. CPC C23C 22/62; C08K 2003/2255; C09D 5/084; C09D 5/086; C08K 5/521; C08K 5/524; C08K 5/053; C08K 5/405; C08K 3/32; C08K 3/22; C08K 3/30; C08L 65/02; C08L 71/02; C08F 120/06; C23C 2222/00; C08K 2003/326; C08K 2003/329; C23C 22/77

(57) ABSTRACT

The present invention relates to a four-function steel surface treatment liquid and a preparation method thereof, the components of raw materials of the four-function steel surface treatment liquid per liter include: phytic acid of 15 g-18 g, hydroxyethylidene-1, 1-diphosphonic acid of 50 g-65 g, phosphoric acid solution of 280 g-320 g, manganous dihydrogen phosphate of 280 g-360 g, thiourea of 5 g-8 g, surfactant of 3 g-6 g, polyethylene glycol of 1 g-2 g, sodium molybdate of 5 g-8 g, and the remaining of water. The four-function steel surface treatment liquid provided by the present invention has the advantages of a good anti-corrosion property and a safe cleaning process, is simple, high efficiency, environmental protection, no hydrogen embrittlement on a metal substrate, no intergranular corrosion, no harm to human skin, no burning, no explosion, and non-toxic, and can be used repeatedly at a normal temperature.

### TECHNICAL FIELI)

The present invention relates to the field of steel surface treatment technology, in particular to a four-function steel surface treatment liquid and a preparation method thereof.

### TECHNICAL BACKGROUND

Steel needs pre-treatment before a workpiece is made, the pretreatment includes degreasing, descaling, phosphating and passivation, advanced pretreatment is the most basic technology that is indispensable for modem surface engineering. At present, most of the domestic steel pre-treatment uses a tank dipping process, a strong alkali degreasing needs to be heated, which produces a lot of corrosive alkali mist, strong acid derusting also produces a lot of acid mist, which seriously affects a worker' health, produces occupational diseases and pollutes an environment, with a lot of waste of clean water resources. In the pre-treatment of the steel, how to ensure the safety of the worker, how to meet the requirements of steel after treatment, and how to reduce the cost of production operations are the problems that need to be solved in this field.

### SUMMARY

In view of the detects in the prior art, the present invention aims at providing a four-function steel surface treatment liquid and a preparation method thereof, the four-function steel surface treatment liquid has the advantages of a good anti-corrosion resistance and a safe cleaning process, is simple, high efficiency, environmental protection, no hydrogen embrittlement on a metal substrate, no intergranular corrosion, no harm to human skin, no burning, no explosion, and non-toxic, and can be used repeatedly in a normal temperature.

To achieve the above objects, the technical solution provided by the present invention is:

The present invention provides a four-function steel surface treatment liquid, the components of the raw materials of the four-function steel surface treatment liquid per liter comprise: phytic acid of 15 g-18 g, hydroxyethylidene-1, 1-diphosphonic acid of 50 g-65 g, phosphoric acid solution of 280 g-320 g, manganous dihydrogen phosphate of 280 g-360 g, thiourea of 5 g-8 g, surfactant of 3 g-6 g, polyethylene glycol of 1(Y-2 g, sodium molybdate of 5 g-8 g, and the remaining of water.

Preferably, the components of the four-function steel surface treatment liquid per liter comprise phytic acid of 16 g, hydroxyethylidene-1, 1-diphosphonic acid (HEDP) of 55 g, phosphoric acid solution of 300 g, manganous dihydrogen phosphate of 320 g, thiourea of 6 g, surfactant of 4 g, polyethylene glycol of 1.5 g, sodium molybdate of 6 g, and the remaining of water.

Preferably, the phosphoric acid solution has a mass fraction of 80% to 90%, preferably 85%; and the water is deionized water.

The components of the raw materials of the four-function steel surface treatment liquid per liter further comprises: pentaerythritol of 4 g-8 g, acrylic acid of 5 g-7 g, tea polyphenol of 3 g-5 g and potassium sulfite of lg-2 g.

The present invention still provides a preparation method of a four-function steel surface treatment liquid, the method subsequently comprises the steps of water softening, blanking, dissolution, primary reaction, filtration, catalysis, secondary reaction, and filtration.

Preferably, the primary reaction has the temperature of 45-55° C., and the primary reaction has the time of 2-3 hours.

Preferably, the secondary reaction has the temperature of 78-86° C., and the secondary reaction has the time of 4-5 hours.

Preferably, the dissolution is performed at a normal temperature without pressure, and continuous stir is performed dudng the dissolution.

The present invention still provides another preparation method a four-function steel surface treatment liquid, comprising the steps of: phytic acid, mixing uniformly hydroxyethylidene-1, 1-diphosphonic acid, phosphoric acid solution, manganous dihydrogen phosphate, thiourea and water, adjusting to be 8,5-8.6, then performing heating; adding the components of the other remaining raw materials in a heated mixture, adjusting the pH to be 4.2-4.4, and then raising temperature; raising the pH of the mixture after the temperature to be 6.4-6.6, then and performing cooling to obtain the four-function steel surface treatment liquid.

Preferably, the heating temperature is 42-45° C., and the heating time is 100-120 min; a heating process specifically comprises: raising the temperature to be 96° C. at the heating rate of 1.2-1.4° C./min, and then keeping the temperature for 40-50 min; a cooling process specifically comprises: decreasing the temperature to be 60-65° C. at the cooling rate of 1.6-1.8° C./min, and then keeping the temperature for 70-90 min, and then decreasing to be 25° C. at the cooling rate of 2-3° C./min.

The technical solution provided by the present invention has the following beneficial effects: (1) The four-function steel surface treatment liquid provided by the present invention solves the problems of acid mist and alkali mist occurring during the cleaning processes of strong acid and alkali, greatly reduces the discharge thereof, protects the health of the worker, eliminates the occurrence of occupational diseases, and protects an environment; (2) the four-function steel surface treatment liquid provided by the present invention has the advantages of a good anti-corrosion resistance and a sate cleaning process, is simple, high efficiency, environmental protection, no hydrogen embrittlement on a metal substrate, no intergranular corrosion, no harm to human skin, no burning, no explosion, and non-toxic, and can be used repeatedly in a normal temperature.

The additional aspects and advantages of the present invention will be set forth and a part thereof will become obvious in the description which follows or will be understood by the practice of the present invention.

### BRIEF DESCRIPTION OF DRAWINGS

FIG. 1 is View I of a result of a salt spray test of a 10-inch ground anchor-OR after treatment with a four-function steel surface treatment liquid prepared in Embodiment 1 of the present invention;

FIG. 2 is View II of a result of a salt spray test of a 10-inch ground anchor-OR after treatment with a four-function steel surface treatment liquid prepared in Embodiment 1 of the present invention;

FIG. 3 is View I of a result of a paint adhesion test of a 16-inch ground anchor-OR after treatment with a four-function steel surface treatment liquid prepared in Embodiment 1 of the present invention;

FIG. 4 is View II of a result of a paint adhesion test of a 16-inch ground anchor-OR after treatment with a four-function steel surface treatment liquid prepared in Embodiment 1 of the present invention;.

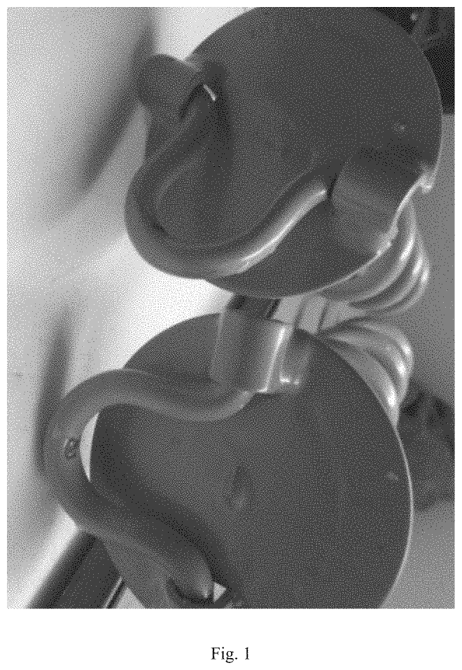

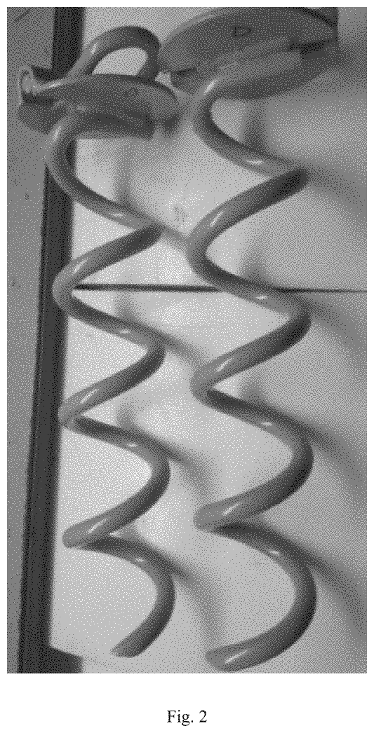

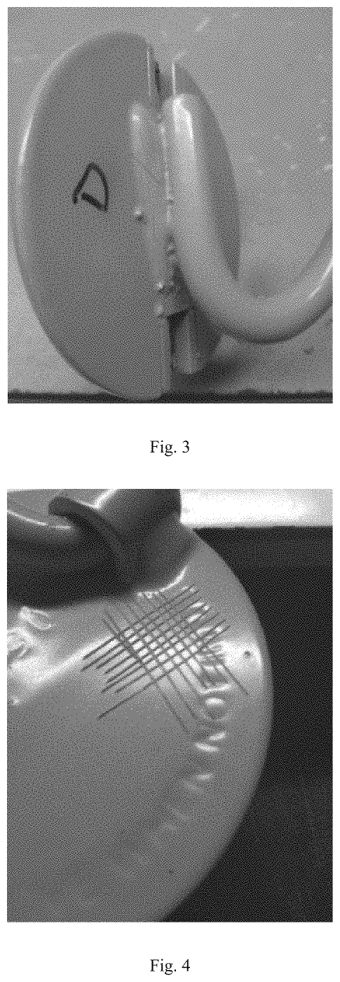

### DETAILED DESCRIPTION

The technical solutions in the embodiments of the present invention will be clearly and completely described in the following with reference to the accompanying drawings in the embodiments of the present invention. The following embodiments are only intended to illustrate the technical solutions of the present invention more clearly, and thus are taken as examples but are not intended to limit the scope of the present invention.

The experimental methods in the following embodiments are conventional methods unless otherwise specified. The test materials used in the following embodiments, unless otherwise specified, were purchased from conventional stores. For the quantitative tests in the following embodiments, three replicate experiments were set up, and the data thereof were the mean or mean±standard deviation of the three replicate experiments.

The components of the raw materials for preparing a four-function steel surface treatment liquid of the present invention are used in matching according to the content per liter, and may be increased or decreased in accordance with the corresponding ratio at the time of production, but the matching ratio between the components is not changed.

The present invention provides a four-function steel surface treatment liquid, and the components of raw materials of the four-function steel surface treatment liquid per liter include: phytic acid of 15 g-18 g, hydroxyethylidene-1, 1-diphosphonic acid (FIEDP) of 50 g-65 g, phosphoric acid solution of 280 g-320 g with the mass ratio of 80%-90% , manganous dihydrogen phosphate of 280 g-360 g, thiourea of 5 g-8 g, surfactant of 3 g-6 g, polyethylene glycol of lg-2 g, sodium molybdate of 5 g-8 g, and the remaining of water;

In a further embodiment of the present invention, the components of the raw materials of the four-function steel surface treatment liquid per liter further include: pentaerythritol of 4 g-8 g, acrylic acid of 5 g-7 g, tea polyphenol of 3 g-5 g, and potassium sulfite of Ig-2 g.

In addition, the present invention also provides a preparation method of the above-mentioned four-function steel surface treatment liquid, including the steps of water softening, blanking, dissolution, primary reaction, filtration, catalysis, secondary reaction and filtration, wherein the primary reaction has the temperature of 45-55° C., the primary reaction has the time of 2-3 hours; the secondary reaction has the temperature of 78-86° C., the secondary reaction has the time of 4-5 hours; the dissolution is performed at a normal temperature without pressure, continuous stir is performed during the dissolution.

Furthermore, the present invention also provides another preparation method of a four-function steel surface treatment liquid, including the following steps:

Mixing uniformly phytic acid, hydroxyethylidene-1, 1-diphosphonic acid, phosphoric acid solution, manganous dihydrogen phosphate, thiourea and water, and adjusting pH to be 8.5-8.6, then performing heating at 42-45° C. for 100-120 min;

Adding components of the other remaining raw materials to a heated mixture, adjusting the pH to be 4.2-4.4, then raising the temperature to be 96° C. at the heating rate of 1.2-1.4° C./min, and then keeping the temperature for 40-50 min;

Adjusting the pH of the mixture after thermal insulation to be 6.4-6.6, then decreasing the temperature to be 60-65° C. at the cooling rate of 1.6-1.8° C./min, then keeping the temperature for 70-90 min, and then decreasing the temperature to be 25° C. at the cooling rate of 2-3° C./min to obtain the four-function steel surface treatment liquid.

The four-function steel surface treatment liquid and the preparation method thereof provided by the present invention will be further described below in conjunction with specific embodiments.

Embodiment 1

The present embodiment provides a four-function steel surface treatment liquid, and the components of the raw materials of the four-function steel surface treatment liquid per liter include: phytic acid of 16 g, hydroxyethylidene-1, 1-diphosphonic acid (HIEDP) of 55 g, phosphoric acid solution of 300 g with the mass ratio of 85 , manganous dihydrogen phosphate of 320 g, thiourea of 6 g, surfactant of 4 g, polyethylene glycol of 1.5 g, sodium molybdate of 6 g, and the remaining of water.

According to the above raw materials, the preparation method of the four-function steel surface treatment liquid subsequently includes the steps of water softening, blanking, dissolution, primary reaction, filtration, catalysis, secondary reaction and filtration; wherein the primary reaction has the temperature of 50° C., the primary reaction has the time of 2.5 hours; the secondary reaction has the temperature of 82° C., and the secondary reaction has the time of 4.6 hours; the dissolution is performed under normal temperature without pressure, and continuous stir is performed during the dissolution.

Embodiment 2

The present embodiment provides a four-function steel surface treatment liquid, and components of the raw materials of the four-function steel surface treatment liquid per liter include: phytic acid of 16 g, hydroxyethylidene-1, 1-diphosphonic acid (HEDP) of 55 g, phosphoric acid solution of 300 g with the mass ratio of 85 , manganous dihydrogen phosphate of 320 g, thiourea of 6 g, surfactant of 4 g, polyethylene glycol of 1.5 g, sodium molybdate of 6 g, and the remaining of deionized water.

According to the above raw materials, the four-function steel surface treatment liquid is prepared by the preparation method provided by the present invention:

Mixing uniformly phytic acid, hydroxyethylidene-1, 1-diphosphonic acid, phosphoric acid solution, manganous dihydrogen phosphate, thiourea and water, adjusting pH-I to be 8.5, and then performing heating at the temperature of 43° C. for 110 min;

Adding components of the other remaining raw materials to a heated mixture, adjusting the pH to be 4.3, and then raising the temperature to be 96° C. at the heating rate of 1.3° C./min, and then keeping the temperature for 45 min;

Adjusting the PH of the mixture after thermal insulation to be 6.5, decreasing the temperature to be 62° C. at the cooling rate of 1.7° C./min and then keeping the temperature for 80 min, and then decreasing the temperature to be 25° C. at the cooling rate of 2.5° C./min to obtain the four-function steel surface treatment liquid.

Embodiment 3

The present embodiment provides a four-function steel surface treatment liquid, and components of the raw materials of the four-function steel surface treatment liquid per liter include: phytic acid of 16 g, hydroxyethylidene-1, 1-diphosphonic acid (HEDP) of 55 g, phosphoric acid solution of 300 g with the mass ratio of 85 , manganous dihydrogen phosphate of 320 g, thiourea of 6 g, surfactant of 4 g, polyethylene glycol of 1.5 g, sodium molybdate of 6 g, pentaerythritol of 7 g, acrylic acid of 6 g, tea polyphenol of 4 g, potassium sulfite of 1.5 g and the remaining of deionized water.

According to the above raw materials, the four-function steel surface treatment liquid is prepared by the preparation method provided by the present invention:

Mixing uniformly phytic acid, hydroxyethylidene-1, 1-diphosphonic acid, phosphoric acid solution, manganous dihydrogen phosphate, thiourea and water, and adjusting pH to be 8.5, and then performing heating at the temperature of 43° C. for 110 min;

Adding components of the other remaining raw materials to a heated mixture, adjusting pH to be 4.3, and then raising the temperature to be 96° C. at the heating rate of 1.3° C./min, and then keeping the temperature for 45 min;

Adjusting the PH of the mixture after thermal insulation to be 6.5, decreasing the temperature to be 62° C. at the cooling rate of 1.7° C./min and then keeping the temperature for 80 min, and then decreasing the temperature to be 25° C. at the cooling rate of 2.5° C./min to obtain the four-function steel surface treatment liquid.

Embodiment 4

The present embodiment provides a four-function steel surface treatment liquid, and components of the raw materials of the four-function steel surface treatment liquid per liter include: phytic acid of 15 g, hydroxyethylidene-1, 1-diphosphonic acid (HEDP) of 65 g, phosphoric acid solution of 280 g with the mass ratio of 80%, manganous dihydrogen phosphate of 360 g, thiourea of 5 g, surfactant of 6 g, polyethylene glycol of 1 g, sodium molybdate of 8 g, pentaerythritol of 8 g, acrylic acid of 7 g, tea polyphenol of 3 g, potassium sulfite of 2 g and the remaining of deionized water.

According to the above raw materials, the four-function steel surface treatment liquid is prepared by a preparation method provided by the present invention:

Mixing uniformly phytic acid, hydroxyethylidene-1, 1-diphosphonic acid, phosphoric acid solution, manganous dihydrogen phosphate, thiourea and water, adjusting pH to be 8.5, then performing heating at the temperature of 42° C. for 100 min;

Adding components of other remaining raw materials to a heated mixture, adjusting pH to be 4.2, then raising the temperature to be 96° C. at the heating rate of 1.2° C./min, and then keeping the temperature for 40 min;

Adjusting the PH of the mixture after thermal insulation to be 6.4, decreasing the temperature to be 60° C. at the cooling rate of 1.6° C./min and then keeping the temperature for 70 min, and then decreasing the temperature to be 25° C. at the cooling rate of 2° C./min to obtain the four-function steel surface treatment liquid.

### COMPARATIVE EXAMPLE 1

The present comparative example provides a four-function steel surface treatment liquid, and components of the raw materials of the four-function steel surface treatment liquid per liter include: phytic acid of 16 g, hydroxyethylidene-1, 1-diphosphonic acid (HEDP) of 55 g, phosphoric acid solution of 300 g with the mass ratio of 85%, thiourea of 6 g, surfactant of 4 g, polyethylene glycol of 1.5 g, sodium molybdate of 6 g, and the remaining of deionized water.

According to the above raw materials, a preparation method of the four-function steel surface treatment liquid includes the steps of water softening, blanking, dissolution, primary reaction, filtration, catalysis, secondary reaction and filtration; wherein the primary reaction has the temperature of 50° C., the primary reaction has the time of 2.5 hours; the secondary reaction has the temperature of 82° C., and the secondary reaction has the time of 4.6 hours; the dissolution is performed under normal temperature without pressure, and continuous stir is performed during the dissolution.

### COMPARATIVE EXAMPLE 2

The present comparative example provides a four-function steel surface treatment liquid, and components of the raw materials of the four-function steel surface treatment liquid per liter include: phytic acid of 16 g, hydroxyethylidene-1, 1-diphosphonic acid (HEDP) of 55 g, phosphoric acid solution of 300 g with the mass ratio of 85 DA manganous dihydrogen phosphate of 320 g, thiourea of 6 g, surfactant of 4 g, polyethylene glycol of 1.5 g, sodium molybdate of 6 g, pentaerythritol of 7 g, acrylic acid of 6 g, tea polyphenol of 4 g, potassium sulfite of 1.5 g and the remaining of deionized water.

According to the above raw materials, the four-function steel surface treatment liquid is prepared:

Mixing uniformly phytic acid, hydroxyethylidene-1, 1-di phosphoni c acid, phosphoric acid solution, manganous dihydrogen phosphate, thiourea and water, adjusting pH to be 8.5, and then performing heating at the temperature of 43° C. for 110 min;

Adding the components of other remaining raw materials to a heated mixture, adjusting the pH to be 4.3, and then raising the temperature to be 96° C. at the heating rate of 1.3° C./min, and then keeping the temperature for 45 min;

Decreasing the temperature of the mixture after thermal insulation to be 62° C. at the cooling rate of 1.7° C./min, and then keeping the temperature for 80 min, and then decreasing the temperature to be 25° C. at the cooling rate of 2.5° C./min to obtain the four-function steel surface treatment liquid.

The four-function steel surface treatment liquid prepared in Embodiments 1-Embodiment 4 of the present invention is systematically evaluated for the effect thereof by a functional test, and the four-function steel surface treatment liquid prepared in Comparative Example 1-Comparative Example 2 is used as a control.
1. Salt Spray Test

Test standard: ASTM 13117.

Experimental equipment: WZQ-03 neutral salt spray test machine.

Product name: 10 inch ground anchor-OR (processing is performed with a four-function steel surface treatment liquid prepared by Embodiment 1-Embodiment 4 and Comparative Example 1-Comparative Example 2 of the present invention, respectively).

Test parameters: (1) Test conditions: pure water of 95% and sodium chloride of 5% are formulated into saline solution of a mass fraction of 5.0% and pH of 4.79;

(2) Process parameters: spray pressure of 0.10 Mpa, saturated barrel temperature of 47.0° C., salt spray box temperature of 35.0° C., collection flow volume of 1.4, collection liquid salinity of 3.9, and the pH of a collection liquid of 6.87.

Test results: After 24 hours and 36 hours of NSS testing, the surface conditions of the different groups of samples are shown in Table 1 below.

TABLE 1
salt spray test results

| | Corrosive conditions on | |
|---|---|---|
| | the surface of the samples | |
| Group | 24 hours | 36 hours |
| Embodiment 1 | No corrosion | Slight corrosion |
| Embodiment 2 | No corrosion | Slight corrosion |
| Embodiment 3 | No corrosion | No corrosion |
| Embodiment 4 | No corrosion | No corrosion |
| Comparative | Moderate | Severe |
| Example 1 | corrosion | corrosion |
| Comparative | Slight | Moderate |
| Example 2 | corrosion | corrosion |

### 2. Paint Adhesion Test

Test standard: ASTM D3359.

Product name: 16 inch ground anchor-OR (processing is performed with a four-function steel surface treatment liquid prepared by Embodiment 1-Embodiment 4 and Comparative Example 1-Comparative Example 2 of the present invention, respectively).

Test results: The surface coating of different groups of samples are shown in Table 2 below.

TABLE 2
the results of paint adhesion test

| | Surface coating conditions |
|---|---|
| Groups | of the samples |
| Embodiment 1 | No shedding, meet 5B requirements |
| Embodiment 2 | No shedding, meet 5B requirements |
| Embodiment 3 | No shedding, meet 5B requirements |
| Embodiment 4 | No shedding, meet 5B requirements |
| Comparative | There is slight shedding |
| Example 1 | |
| Comparative | There is moderate shedding |
| Example 2 | |

It should be noted that, unless otherwise stated, technical or scientific terms used herein shall be taken to mean the ordinary meaning as understood by a person skilled in the art. The relative steps, numerical expressions and numerical values of the components and steps set forth in the embodiments are not intended to limit the scope of the invention unless otherwise specified. In all of the embodiments shown and described herein, unless otherwise specified, any specific value should be construed as merely illustrative and not as a limitation, and thus, other examples of the exemplary embodiments may have different values.

In the description of the present invention, it is to be understood that the terms “first” and “second” are used for descriptive purposes only and are not to be construed as indicating or implying a relative importance or implicitly indicating the number of technical features indicated. Thus, features defining as “first” or “second” may include one or more of the features, either explicitly or implicitly. In the description of the present invention, the meaning of “a plurality of” is two or more unless clearly and specifically defined.

Finally, it should be noted that the above embodiments are merely illustrative of the technical solutions of the present invention, and are not intended to be limitation; although the present invention has been described in detail with reference to the foregoing embodiments, a person skilled in the art will understand that the technical solutions described in the foregoing embodiments may be modified, or some or all of the technical features may be equivalently replaced; and these modifications or substitutions do not deviate from the technical solutions of the embodiments of the present invention and should all be covered by the scope of the present invention.

1. A four-function steel surface treatment liquid, characterized in that the components of the raw materials of the four-function steel surface treatment liquid per liter comprise: phytic acid of 15 g-18 g, hydroxyethylidene-1, 1-diphosphonic acid of 50 g-65 g, phosphoric acid solution of 280 g-320 g, manganous dihydrogen phosphate of 280 g-360 g, thiourea of 5 g-8 g, surfactant of 3 g-6 g, polyethylene glycol of 1 g-2 g, sodium molybdate of 5 g-8 g, and the remaining of water.

2. The four-function steel surface treatment liquid according to claim 1, characterized by having phytic acid of 16 g, hydroxyethylidene-1, 1-diphosphonic acid of 55 g, phosphoric acid solution of 300 g, manganous dihydrogen phosphate of 320 g, thiourea of 6 g, surfactant of 4 g, polyethylene glycol of 1.5 g, sodium molybdate of 6 g, and the remaining of water.

3. The four-function steel surface treatment liquid according to claim 1, characterized in that the phosphoric acid solution has a mass fraction of 80% to 90%, preferably 85%; and the water is deionized water.

4. The four-function steel surface treatment liquid according to claim 1, characterized in that the components of the raw materials of the four-function steel surface treatment liquid per liter further comprises: pentaerythritol of 4 g-8 g, acrylic acid of 5 g-7 g, tea polyphenol of 3 g-5 g and potassium sulfite of lg-2 g.

5. A preparation method of a four-function steel surface treatment liquid according to claim 1, characterized in that the method subsequently comprises the steps of water softening, blanking, dissolution, primary reaction, filtration, catalysis, secondary reaction, and filtration.

6. A preparation method of a four-function steel surface treatment liquid according to claim 2, characterized in that the method subsequently comprises the steps of water softening, blanking, dissolution, primary reaction, filtration, catalysis, secondary reaction, and filtration.

7. A preparation method of a four-function steel surface treatment liquid according to claim 3, characterized in that the method subsequently comprises the steps of water softening, blanking, dissolution, primary reaction, filtration, catalysis, secondary reaction, and filtration.

8. A preparation method of a four-function steel surface treatment liquid according to claim 4, characterized in that the method subsequently comprises the steps of water softening, blanking, dissolution, primary reaction, filtration, catalysis, secondary reaction, and filtration.

9. The preparation method of the four-function steel surface treatment liquid according to claim 5, characterized in that the primary reaction has the temperature of 45-55° C., and the primary reaction has the time of 2-3 hours.

10. The preparation method of the four-function steel surface treatment liquid according to claim 5, characterized in that the secondary reaction has the temperature of 78-86° C., and the secondary reaction has the time of 4-5 hours.

11. The preparation method of the four-function steel surface treatment liquid according to claim 5, characterized in that the dissolution is performed at a normal temperature without pressure, and continuous stir is performed during the dissolution.

12. The preparation method of the four-function steel surface treatment liquid according to claim 1, comprising the steps of: phytic acid, mixing uniformly hydroxyethylidene-1, 1-diphosphonic acid, phosphoric acid solution, manganous dihydrogen phosphate, thiourea and water, adjusting pH to be 8.5-8.6, then performing heating; adding the components of the other remaining raw materials in a heated mixture, adjusting the pH to be 4.2-4.4, and then raising temperature; raising the pH of the mixture after the temperature to be 6.4-6.6, then and performing cooling to obtain the four-function steel surface treatment liquid.

13. The preparation method of the four-function steel surface treatment liquid according to claim 2, characterized by comprising the steps of: phytic acid, mixing uniformly hydroxyethylidene-1, 1-diphosphonic acid, phosphoric acid solution, manganous dihydrogen phosphate, thiourea and water, adjusting pH to be 8.5-8.6, then performing heating; adding the components of the other remaining raw materials in a heated mixture, adjusting the pH to be 4.2-4.4, and then raising temperature;
raising the pH of the mixture after the temperature to be 6.4-6.6, then and performing cooling to obtain the four-function steel surface treatment liquid.

14. The preparation method of the four-function steel surface treatment liquid according to claim 3, characterized by comprising the steps of: phytic acid, mixing uniformly hydroxyethylidene-1, 1-diphosphonic acid, phosphoric acid solution, manganous dihydrogen phosphate, thiourea and water, adjusting pH to be 8.5-8.6, then performing heating; adding the components of the other remaining raw materials in a heated mixture, adjusting the pH to be 4.2-4.4, and then raising temperature;
raising the pH of the mixture after the temperature to be 6.4-6.6, then and performing cooling to obtain the four-function steel surface treatment liquid.

15. The preparation method of the four-function steel surface treatment liquid according to claim 4, characterized by comprising the steps of: phytic acid, mixing uniformly hydroxyethylidene-1, 1-diphosphonic acid, phosphoric acid solution, manganous dihydrogen phosphate, thiourea and water, adjusting pH to be 8.5-8.6, then performing heating; adding the components of the other remaining raw materials in a heated mixture, adjusting the pH to be 4.2-4.4, and then raising temperature;
raising the pH of the mixture after the temperature to be 6.4-6.6, then and performing cooling to obtain the four-function steel surface treatment liquid.

16. The preparation method of the four-function steel surface treatment liquid according to claim 12, characterized in that the heating temperature is 42-45° C., and the heating time is 100-120 min; a heating process specifically comprises: raising the temperature to be 96° C. at the heating rate of 1.2-1.4° C./min, and then keeping the temperature for 40-50 min; a cooling process specifically comprises: decreasing the temperature to be 60-65° C. at the cooling rate of 1.6-1.8° C./min and then keeping the temperature for 70-90 min, and then decreasing to be 25° C. at the cooling rate of 2-3° C./min.
